(19) United States
(12) Patent Application Publication
(10) Pub. No.: US 2025/0244165 A1
(43) Pub. Date: Jul. 31, 2025

(54) System For On-Board Measurement Of Dynamic Wheel / Rail Loads

(71) Applicant: Transportation Technology Center, Inc. d/b/a MxV Rail, Pueblo, CO (US)

(72) Inventors: Yuqing Zeng, Pueblo, CO (US); Matthew Ward Witte, Tecumseh, MI (US); NIcholas Graham Wilson, Colorado Springs, CO (US)

(73) Assignee: Transportation Technology Center, Inc. d/b/a MxV Rail, Pueblo, CO (US)

(21) Appl. No.: 19/041,091

(22) Filed: Jan. 30, 2025

Related U.S. Application Data
(60) Provisional application No. 63/627,237, filed on Jan. 31, 2024.

(51) Int. Cl. G01G 19/08; B61L 15/00

(52) U.S. Cl. CPC G01G 19/086; B61L 15/0081

(57) ABSTRACT

A system for on-board measurement and modelling of dynamic wheel/rail loads employs an accelerometer in addition to force sensors at the axle box of the test vehicle. The force sensors accurately measure dynamic wheel/rail force at low frequencies. The force transfer function at higher frequencies is calculated as a predetermined function of both the accelerometer and force sensor data. For example, this can be calculated by means of a predetermined compensation force transfer function in terms of both the force and acceleration readings.

### RELATED APPLICATION

The present application is based on and claims priority to the Applicant's U.S. Provisional Patent Application 63/627,237, entitled “System for On-Board Measurement of Dynamic Wheel/Rail Loads,” filed on Jan. 31, 2024.

### BACKGROUND OF THE INVENTION

Field of the Invention. The present invention relates generally to the field of measurement of dynamic wheel/rail loads in the railroad industry. More specifically, the present invention discloses an improved system for on-board measurement and modelling of wheel/rail loads.

Statement of the Problem. Railroad wheels may develop anomalies during their service life. Significantly, out-of-round conditions can cause dynamic loads, such as rolling impacts, between the wheel and rail. The North American rail industry relies on sets of rails instrumented with strain gauges to locate, evaluate and indicate severely defective wheels for removal. Because wheelset replacement is the highest single interchange repair cost for North American freight railways, consistent indication is necessary for fair and objective cost sharing.

A wide variety of sensor systems have been used for many years in the railroad industry to measure and model wheel/rail (W/R) loads. Conventional load cells and strain gauges are commonly used to measure such static loads, but have distinct limitations in measuring dynamic loads.

In particular, one conventional on-board system for measuring and modeling W/R loads uses a set of force sensors to measure forces at the axle box as the test vehicle travels along the rails (AAR standard S-6101, version 2021). This approach is useful for measuring static W/R loads and dynamic loads at relatively low frequencies. When compared to scale weights, the static load values measured at the bearing adapter agreed well with 5 percent of scale weight at every location. However, verification tests using sets of rails instrumented with strain gauges (also known as a Wheel Impact Load Detector or WILD) indicate that the AAR standard has shortcomings in terms of accurately measuring dynamic loads at higher frequencies.

FIG. 5 shows the conventional lumped-parameter model for this type of instrumentation. FIG. 6 is a plot of the amplitude of the transfer function for a typical freight car. Note that the amplitude response curve 32 falls off rapidly well above 10 Hz. Therefore, a need exists for an on-board measurement system that is accurate over a wide range of dynamic W/R loads.

Solution to the Problem. The present invention provides an improved on-board system for measuring dynamic W/R loads at higher frequencies by adding an accelerometer in addition to force sensors at the axle box of the test vehicle.

### SUMMARY OF THE INVENTION

This invention provides a system for on-board measurement and modelling of dynamic wheel/rail loads having an accelerometer in addition to force sensors at the axle box of the test vehicle. The force sensors accurately measure dynamic wheel/rail force at low frequencies. The force transfer function at higher frequencies is calculated as a predetermined function of both the accelerometer and force sensor data. For example, this can be calculated by means of a predetermined compensation force transfer function in terms of both the force and acceleration readings.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified diagram of a rail vehicle 20 equipped with the instrumented bearing adapter 28 and on-board instrumentation 50.

FIG. 2 is an axonometric view of the instrumented bearing adapter 28 with an accelerometer 40 installed between an axle and side frame of a railcar 20.

FIG. 3 is an axonometric view of the instrumented bearing adapter 28.

FIG. 4 is a lumped-parameter model of the present invention.

FIG. 5 is a lumped-parameter model for the current standard system for measuring wheel/rail loads (AAR Standard 6101) using load cells.

FIG. 6 is a plot of the amplitude of the transfer function from the W/R force to the bearing adapter force for the lumped-parameter model in FIG. 5.

FIG. 7 is a lumped-parameter model of the W/R force 60 to acceleration at the bearing adapter.

FIG. 8 is a plot of the amplitude of the transfer function for the lumped-parameter model in FIG. 7.

FIG. 9 is a plot showing the amplitudes of the transfer functions for the load cells and for the accelerometer, and also showing the flattened amplitude of the transfer function for the present invention corresponding to FIG. 4.

FIG. 10 is a plot comparing the magnitudes of the transfer functions for the current standard system and the present invention with different mass and damping conditions.

FIG. 11 is a simplified diagram of the measurement configuration in one embodiment of the present invention.

FIG. 12 is a plot comparing the W/R impact forces measured by a high-accuracy instrumented wheelset (curve 62) and the present invention (curve 64).

### DETAILED DESCRIPTION OF THE INVENTION

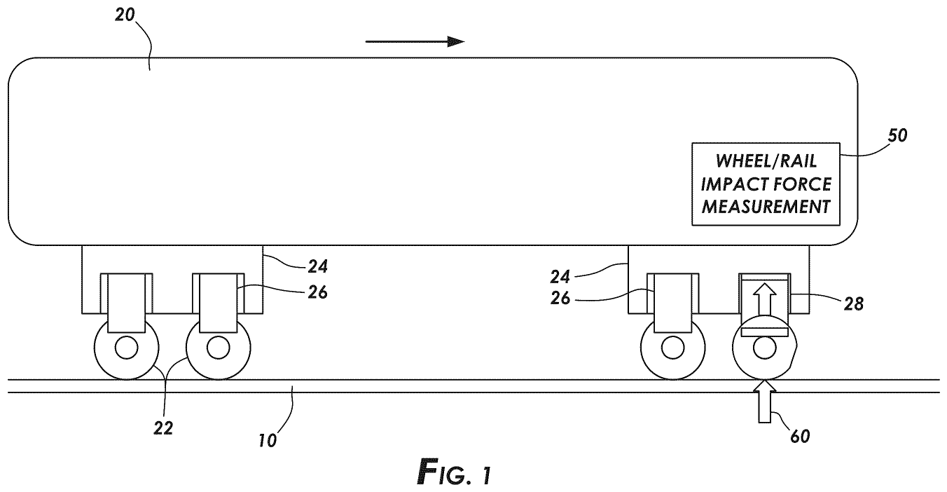

FIG. 1 is a simplified diagram of a test rail vehicle 20 rolling along rails 10. The rail vehicle 20 has a generally conventional configuration with the car body supported on two bolsters, each of which are supported on two opposing side frames 24. Pairs of wheels 22 are mounted on axles supported by bearing adapters 26 attached to the side frames 24 on each bolster in the conventional manner.

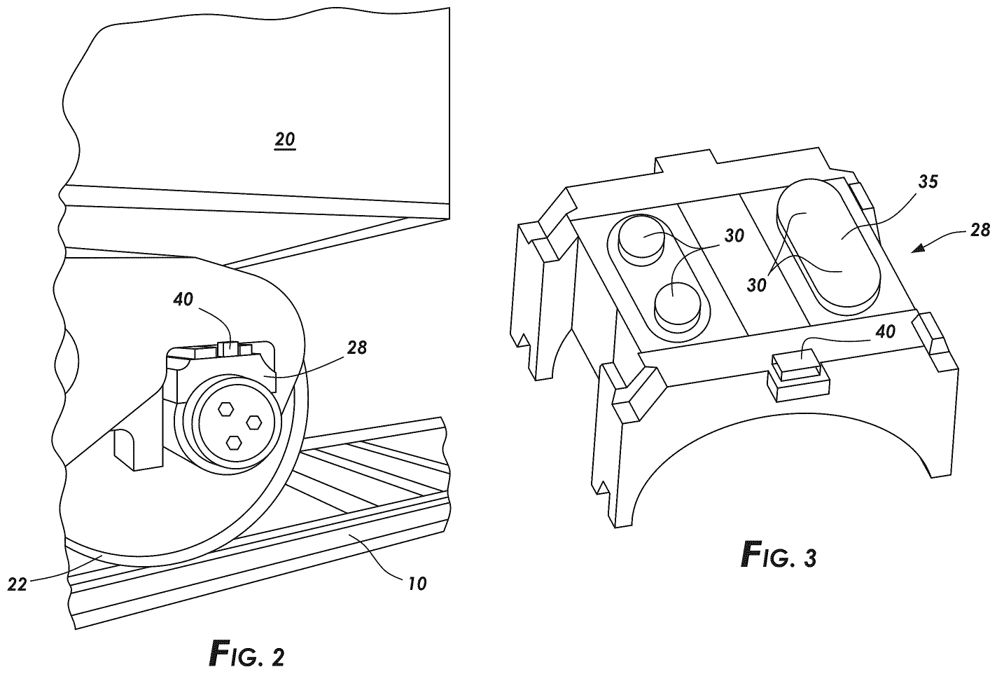

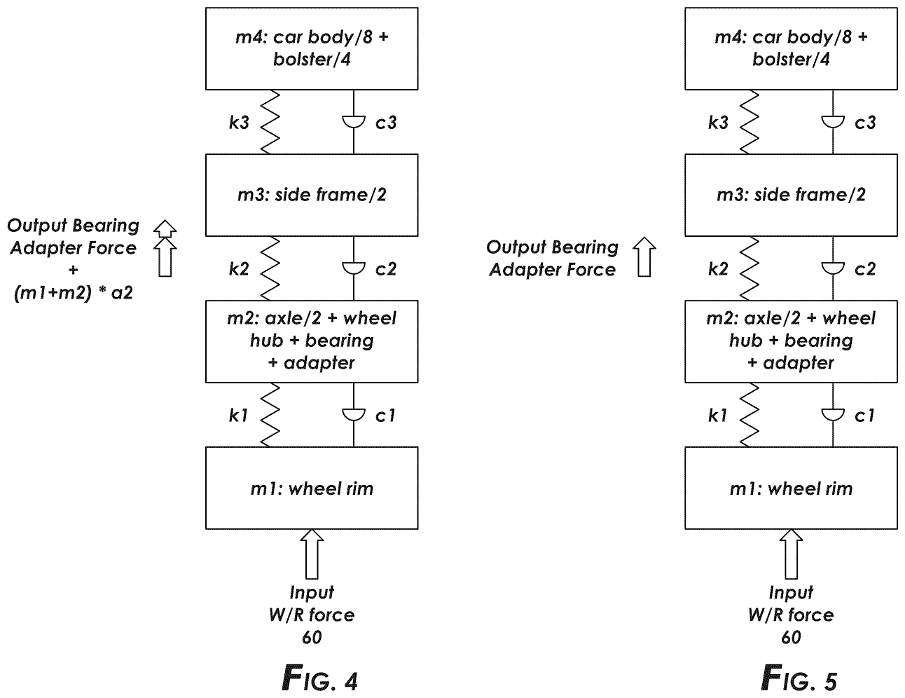

A number of load cells 30 and accelerometers 40 are strategically placed on the load path supporting the vehicle weight to measure nominal and transient load conditions 60 originating from the wheel/rail interface. In one embodiment of the present system, selected bearing adapters 28 are modified to include a set of force sensors 30 (e.g., conventional load cells) to measure forces carried by the bearing adapter, as well as a number of accelerometers 40 to measure acceleration, as shown in FIGS. 2 and 3. The load cells 30 can be equipped with a protective cover 35 as shown in FIG. 3. Vertical forces and accelerations are of primary interest in measuring W/R loads 60, although other force and acceleration vectors can also be measured using the present invention. Preferably, the load cells 30 and accelerometers 40 are mounted adjacent to an axle for optimal high frequency response.

Data from the force sensors 30 and accelerometers 40 can be input to on-board instrumentation 50 for analysis and storage. Preferably, the on-board instrumentation 50 includes a computer processor and data storage. It may also include a global positioning system (GPS) device to track the location of the test vehicle 20 during testing and a database to allow storage of test data keyed to the vehicle's location. The on-board instrumentation 50 can also be equipped with a communications link for radio or cellular communications with a remote central office.

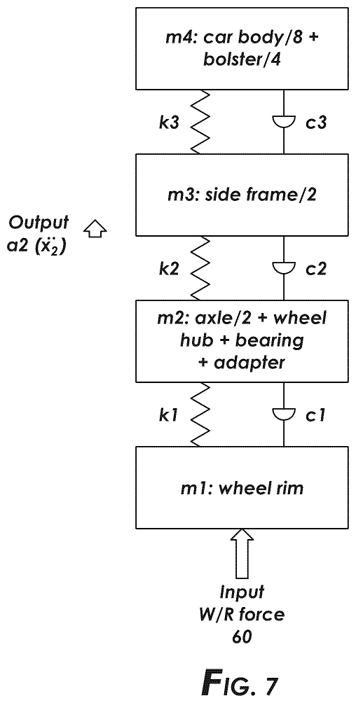

The frequency response limitations of the force sensors 30 were previously discussed. FIG. 5 is a lumped-parameter model for the current standard system for measuring wheel/rail loads (AAR Standard 6101) using such load cells 30. The corresponding system equations for FIG. 5 are:

$$\begin{matrix}( {Ms}^{2} + Cs + K ) {X}_{S} = [ \begin{matrix}1 \\ 0 \\ 0 \\ 0\end{matrix} ] {F}_{S} \\ {X}_{S} = {( {Ms}^{2} + Cs + K )}^{- 1} [ \begin{matrix}1 \\ 0 \\ 0 \\ 0\end{matrix} ] {F}_{S}\end{matrix}$$

The corresponding transfer function is:

$$\frac{{c}_{2} \times ( {x}_{2 S} - {x}_{3 S} ) \times s + {k}_{2} \times ( {x}_{2 S} - {x}_{3 S} )}{{F}_{S}}$$

The resulting amplitude response curve 32 is illustrated in FIG. 6. Load cell measurements that are uncompensated by acceleration data are accurate to represent force transfer for the low frequency content of the dynamic load signal, as shown for example in FIG. 6. But, the uncompensated force transfer function is nonlinear and generally underestimates the force transfer at input frequencies above just a few Hertz.

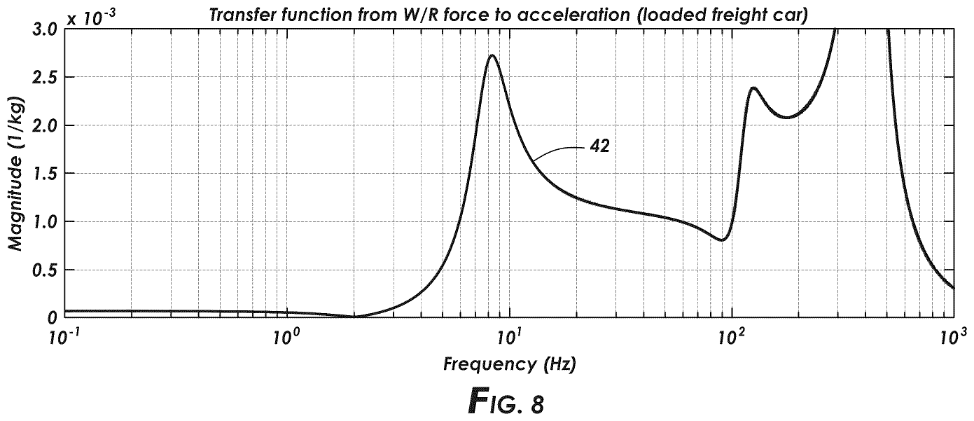

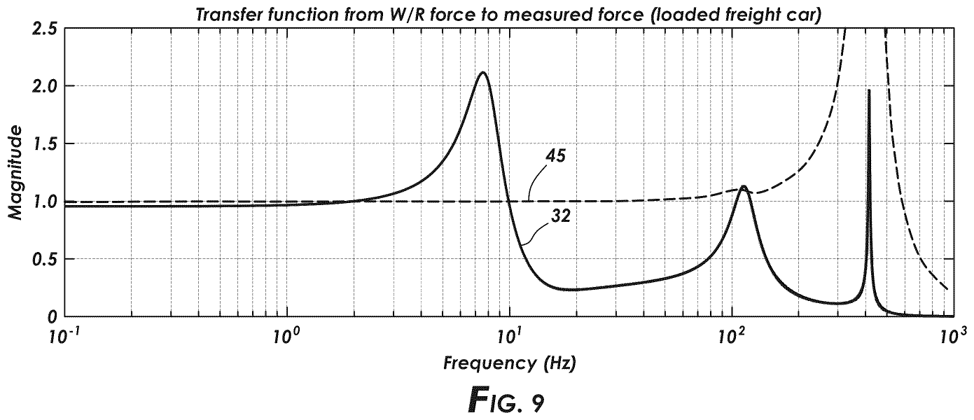

The present system addresses this shortcoming by adding a number of accelerometers 40 mounted on the test vehicle 20 along the load path supporting the vehicle weight. Preferably, the accelerometers 40 should be mounted adjacent to an axle. For example, the accelerometers 40 can be mounted at an axle box in the case of a passenger car, or a bearing adapter for a freight car. The acceleration data from the accelerometers 40 are also frequency dependent, as shown by the amplitude response curve 42 in FIG. 8. A corresponding lumped-parameter model for an accelerometer 40 attached to the instrumented bearing adapter 28 is provided in FIG. 7. The corresponding transfer function is:

$$\frac{{x}_{2 S} \times {s}^{2}}{{F}_{S}}$$

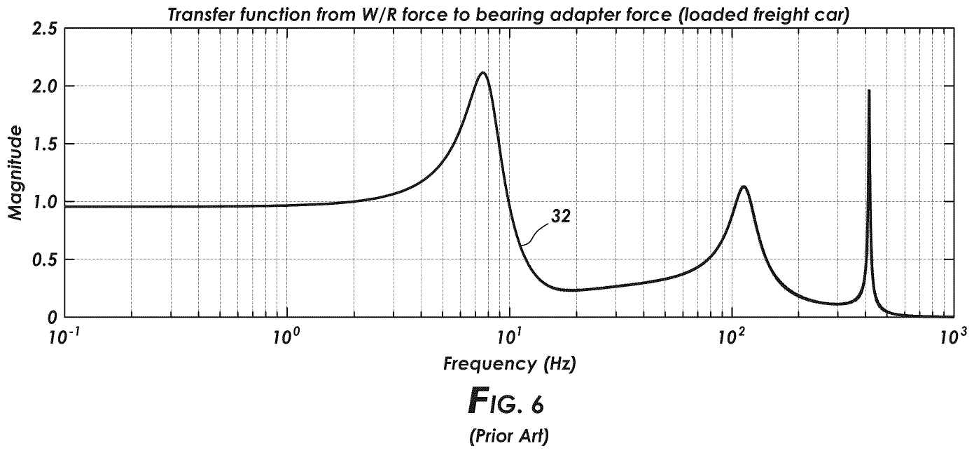

FIG. 4 illustrates a lumped-parameter model of one embodiment of the present invention. The corresponding transfer function relating both acceleration and the measured forces to the W/R forces 60 is:

$$\frac{( {m}_{1} + {m}_{2} ) \times {x}_{2 S} \times {s}^{2} + {c}_{2} \times ( {x}_{2 S} - {x}_{3 S} ) \times s + {k}_{2} \times ( {x}_{2 s} - {x}_{3 S} )}{{F}_{S}}$$

This combined transfer function can be used to develop a compensation algorithm that combines the acceleration and measured force data to more accurately calculate W/R forces 60.

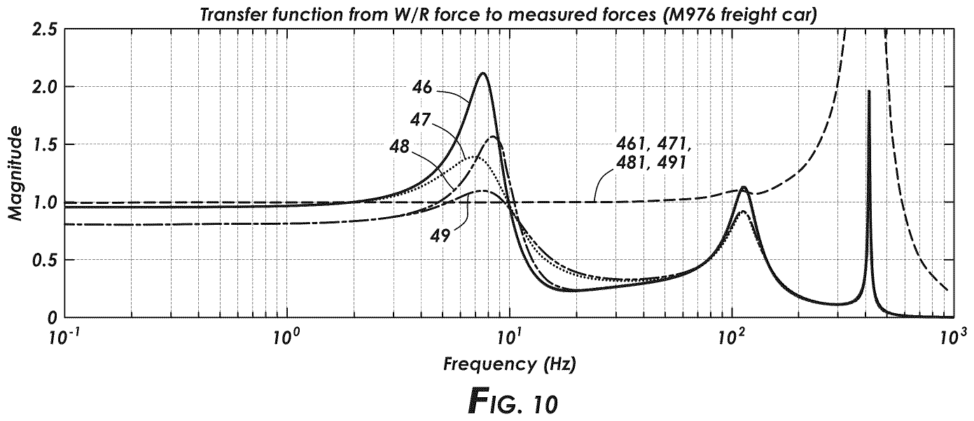

After initial calibration, the compensation algorithm is applied by the processor to more accurately reflect the dynamic wheel/rail loading as measured by both sets of on-board sensors 30, 40. A mathematical model can then be derived from the free body diagram in FIG. 4 and the corresponding transfer function above to represent the force transfer in terms of both the force and acceleration data at key points in the load path. With appropriate sample rate and filter rates applied to the load cells and accelerometers, the dynamic load 60 at the wheel/rail interface can be accurately measured at input frequencies up to approximately 80 Hz using this force transfer function based on FIG. 4. As depicted in FIG. 9, this provides a measurement scheme and mathematical model to flatten the force transfer function 45 over an extended frequency range, thus producing accurate dynamic wheel/rail force 60 measurements within a wider frequency range. To check if the present system is suitable for different kinds of cars, FIG. 10 compares the transmissibility function of traditional instrumentation and the present system under different loads and damping. Although the results of the conventional method (curves 46, 47, 48 and 49) vary greatly, the results of the present invention (curves 461, 471, 481 and 491) are almost unchanged as the mass and damping changes, thereby showing the present system is stable and has the potential for use in WILD dynamic validation.

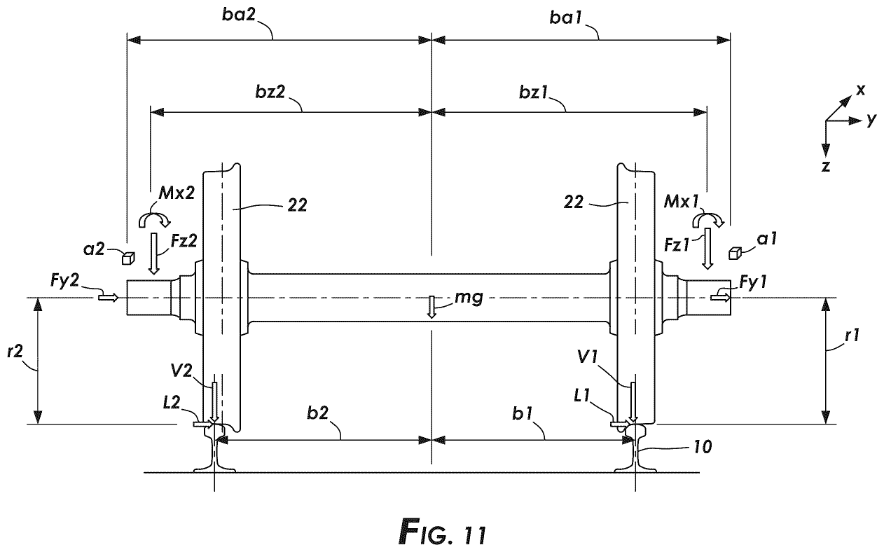

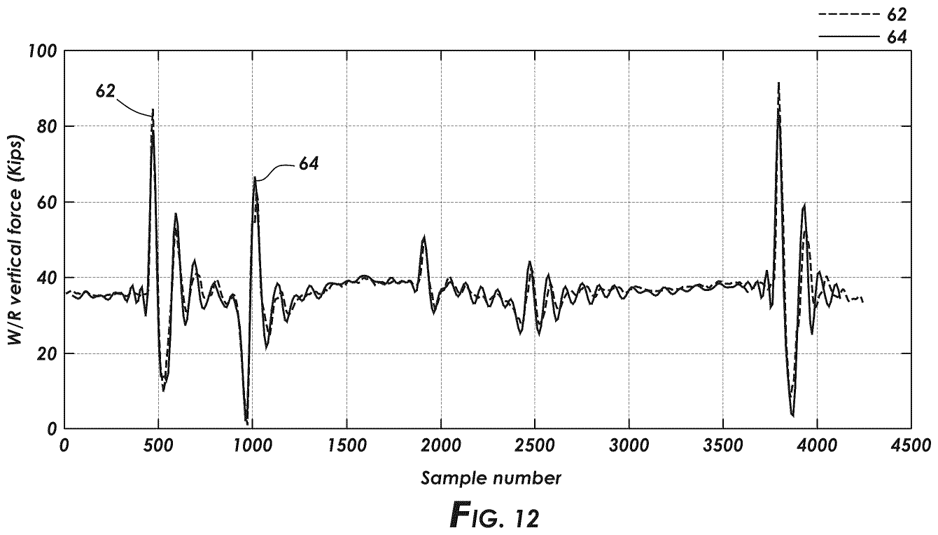

FIG. 11 is a simplified diagram of a measurement configuration for the present invention. Fz1, Fz2, Mx1 and Mx2 can be measured by the force sensors 30 of the instrumented bearing adapters 28, and a1 and a2 can be measured by the accelerometers 40. After introducing some acceptable assumptions, such as negligible lateral axle loads and a symmetric structure, the following measurement equations can be derived for the wheel/rail forces, V₁ and V₂:

$$\{ \begin{matrix}{V}_{1} = - \frac{mg}{2} - {F}_{z 1} \frac{b + {b}_{z}}{2 b} - {F}_{z 2} \frac{b - {b}_{z}}{2 b} + \frac{m}{2} \times \frac{{a}_{1} + {a}_{2}}{2} + \frac{J}{2 b} \times \frac{( {a}_{1} - {a}_{2} )}{2 {b}_{a}} - \frac{{M}_{x 1} + {M}_{x 2}}{2 b} \\ {V}_{2} = - \frac{mg}{2} - {F}_{z 1} \frac{b - {b}_{z}}{2 b} - {F}_{z 2} \frac{b + {b}_{z}}{2 b} + \frac{m}{2} \times \frac{{a}_{1} + {a}_{2}}{2} + \frac{J}{2 b} \times \frac{( {a}_{1} - {a}_{2} )}{2 {b}_{a}} + \frac{{M}_{x 1} + {M}_{x 2}}{2 b}\end{matrix}$$

In these equations, m and J are mass and moment of inertia. For example, these equations can be implemented by means of a conventional computer processor or dedicated hardware as part of the on-board instrumentation 50 that periodically receives force and acceleration data from the force sensors and accelerometers as inputs, and outputs corresponding wheel/rail forces.

FIG. 12 is a plot comparing the W/R impact forces measured by a high-accuracy instrumented wheelset (curve 62) and the present invention (curve 64). The difference between peaks is within 10% and the correlation coefficient is greater than 0.9.

For example, the present invention can be used to validate wheel impact load detectors for indicating wheelset removal during interchange service. The present system can be employed to measure W/R loads 60 at a specific frequency or range of frequencies (e.g., at frequencies often encountered in the railroad industry based on past empirical data). The processor of the on-board instrumentation 50 can also be used to analyze and identify frequencies of interest by Fourier analysis of the force and/or acceleration data.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. A system for measuring wheel/rail loads on a rail vehicle moving along rails and having wheels mounted on axles defining a load path supporting the vehicle's weight, said system comprising:
a force sensor mounted on the vehicle on the load path supporting the vehicle's weight and outputting force data;
an accelerometer mounted on the vehicle on the load path supporting the vehicle's weight and outputting acceleration data; and
instrumentation calculating the wheel/rail load as a predetermined function of said force and acceleration data.

2. The system of claim 1 wherein the force sensor and accelerometer are mounted adjacent to an axle.

3. The system of claim 2 wherein the vehicle has bearing adapters adjacent to the axles, and wherein the force sensor and accelerometer are mounted on a bearing adapter.

4. The system of claim 2 wherein the vehicle has axle boxes adjacent to the axles, and wherein the force sensor and accelerometer are mounted at an axle box.

5. The system of claim 1 wherein said predetermined function is derived from a lumped-parameter model of the force transfer function from the wheel/rail load to the force sensor and accelerometer.

6. The system of claim 1 wherein said predetermined function employs the acceleration data for high-frequency compensation.

7. The system of claim 1 wherein said instrumentation further comprises storage storing the calculated wheel/rail loads as the vehicle moves along the rails.

8. The system of claim 1 wherein the instrumentation is onboard the rail vehicle.

9. A system for measuring wheel/rail loads on a rail vehicle moving along rails and having wheels mounted on axles with bearing adapters adjacent to the axles, said system comprising:
a force sensor mounted on a bearing adapter and outputting force data;
an accelerometer mounted on a bearing adapter and outputting acceleration data; and
instrumentation calculating the wheel/rail load as a predetermined function of said force and acceleration data derived from a lumped-parameter model of the force transfer function from the wheel/rail load to the force sensor and accelerometer.

10. The system of claim 9 wherein said predetermined function employs the acceleration data for high-frequency compensation.

11. The system of claim 9 wherein said instrumentation further comprises storage storing the calculated wheel/rail loads as the vehicle moves along the rails.

12. The system of claim 9 wherein the instrumentation is onboard the rail vehicle.
